(19) United States
(12) Patent Application Publication
(10) Pub. No.: US 2012/0207516 A1
(43) Pub. Date: Aug. 16, 2012

(54) Collecting Device and Image Forming Apparatus

(75) Inventors: Kazuhiro NISHIYAMA, Shiojiri-shi (JP); Akihiro GOMI, Fujimi-machi (JP); Tsutomu SASAKI, Matsumoto-shi (JP)

(73) Assignee: SEIKO EPSON CORPORATION, Tokyo (JP)

(21) Appl. No.: 13/359,943

(22) Filed: Jan. 27, 2012

(30) Foreign Application Priority Data
Feb. 15, 2011 (JP) 2011-029311

(51) Int. Cl. G03G 15/11

(52) U.S. Cl. 399/249

(57) ABSTRACT

A collecting device according to the invention includes: a collecting unit that collects a liquid developer containing toner and a carrier liquid; a collected-liquid storage that stores the liquid developer collected by the collecting unit; a first transporting path that transports the liquid developer stored in the collected-liquid storage; a second transporting path that transports the liquid developer stored in the collected-liquid storage; and a control unit that switches transportation of the liquid developer stored in the collected-liquid storage to the first transporting path or the second transporting path.

### BACKGROUND

1. Technical Field

The present invention relates to an image forming apparatus for various uses, such as a facsimile, a printer, and a copy machine, which forms an image, using a liquid developer, and a collecting device that collects the liquid developer used in developing in the image forming apparatus.

2. Related Art

Various wet type image forming apparatuses that develop a latent image, using a high-viscosity liquid developer formed by dispersing toner made of solid components into a liquid solvent, and visualize an electrostatic latent image have been proposed. The developer used in the wet type image forming apparatuses is made by suspending solid contents (toner particles) into a high-viscosity organic solvent (carrier liquid) having electric insulation, which is made of silicon oil, mineral oil, or food oil, in which the diameter of the toner particles is very small, around 1 μm. It is possible in the wet type image forming apparatuses to achieve high quality in comparison to dry type image forming apparatuses using a powder type of toner particles with particle diameter of about 7 μm, by using fine toner particles.

In the image forming apparatuses using the liquid developer, it has been attempted to efficiently use the liquid developer in various ways by reusing the liquid developer that has not contributed to visualizing the electrostatic latent image.

An image forming apparatus that reuses the liquid developer is disclosed in JP-A-2009-98489. A sweep roller is disposed in the image forming apparatus to remove toner (toner fog) that causes fog in an image. The sweep roller removes toner fog on the skin of a photoreceptor while moving at a substantially constant speed with the surface in contact with the photoreceptor. The carrier liquid-rich liquid developer removed by the sweep roller is sent temporarily through a storage to and adjusted in concentration in a concentration adjusting unit and then reused.

In the image forming apparatus disclosed in JP-A-2009-98489, since the carrier liquid-rich liquid developer removed by the sweep roller is always transported to the concentration adjusting unit, when images with a high streak rate are continuously printed, the concentration of the liquid developer in the concentration adjusting unit rapidly decreases. In particular, when sufficient adjustment of concentration is not performed in the concentration adjusting unit, the image is not developed with a predetermined range of concentration and the quality of the formed image may be deteriorated.

### SUMMARY

According to an aspect of the invention, there is provided a collecting device including: a collecting unit that collects a liquid developer containing toner and a carrier liquid; a collected-liquid storage that stores the liquid developer collected by the collecting unit; a first transporting path that transports the liquid developer stored in the collected-liquid storage; a second transporting path that transports the liquid developer stored in the collected-liquid storage; and a control unit that switches transportation of the liquid developer stored in the collected-liquid storage to the first transporting path or the second transporting path.

The collecting device may further include an auger disposed in the collected-liquid storage and transporting the liquid developer stored in the collected-liquid storage by rotating, in which the control unit may transport the liquid developer to the first transporting path or the second transporting path by changing the rotational direction of the auger.

According to another aspect of the invention, there is provided an image forming apparatus including: a latent image carrier that forms a latent image; an exposing unit that forms the latent image on the latent image carrier; a developing unit that includes a developing roller forming the latent image on the latent image carrier by carrying a liquid developer containing toner and a carrier liquid; a squeeze unit that includes a squeeze roller squeezing the latent image carrier in contact with the latent image carrier where the latent image is developed and a squeeze roller cleaning member collecting the liquid developer by cleaning the squeeze roller in contact with the squeeze roller; a collected-liquid storage that stores the liquid developer collected by the squeeze roller cleaning member; a first transporting path that transports the liquid developer stored in the collected-liquid storage; a second transporting path that transports the liquid developer stored in the collected-liquid storage; and a control unit that switches transportation of the liquid developer stored in the collected-liquid storage to the first transporting path or the second transporting path.

In the image forming apparatus, the developing unit may include a developing roller cleaning member that collects the liquid developer by cleaning the developing roller in contact with the developing roller and a collecting container that stores the liquid developer collected by the developing roller cleaning member, and the first transporting path may transport the liquid developer stored in the collected-liquid storage to the collecting container.

The collecting device may further include an auger disposed in the collected-liquid storage and transporting the liquid developer stored in the collected-liquid storage, in which the control unit may transport the liquid developer to the first transporting path or the second transporting path by changing the rotational direction of the auger.

The image forming apparatus may further include a second auger that transports the liquid developer stored in the collecting container from one side to the other side in the axial direction of the developing roller, in which the first transporting path may transport the liquid developer to one side of the collecting container.

The image forming apparatus may further include a developer supply unit that supplies the liquid developer to the developing unit, in which the second transporting path may transport the liquid developer stored in the collected-liquid storage to the developer supply unit.

In the image forming apparatus, the control unit may switch transportation of the liquid developer to the first transporting path or the second transporting path on the basis of the toner concentration of the liquid developer stored in the developer supply unit or the liquid amount in the developer supply unit.

As described above, according to the collecting device and the image forming apparatus of the invention, as the liquid developer collected by the collecting unit is switched to the first transporting path that largely influences the toner concentration of the liquid developer that is used for forming an image or the second transporting path that less influences the toner concentration, it is possible to provide an image forming apparatus that can perform continuous printing by suppressing changes in concentration and level of the liquid developer stored in the developer supply unit, even if the concentration of the collected liquid developer is changed by a change of the streak rate.

### BRIEF DESCRIPTION OF THE DRAWINGS

The invention will be described with reference to the accompanying drawings, wherein like numbers reference like elements.

FIG. 1 is a view showing the configuration of an image forming apparatus according to an embodiment of the invention.

FIG. 2 is a view showing the configuration of an image forming unit, a developing unit, and a developer supply unit.

FIG. 3 is a view showing the configuration of an image forming unit, a developing unit, and a developer supply unit.

FIGS. 4A and 4B are views showing squeeze rollers and the concentration of collected liquid in a collected-liquid storage to a streak rate.

FIG. 5 is a view showing the concentration of a collected developer to a streak rate.

FIG. 6 is a view showing the concentration of a collected developer to a streak rate of the embodiment.

FIG. 7 is a flowchart showing drive control of an auger.

FIG. 8 is a view showing drive control of an auger according to another embodiment.

### DESCRIPTION OF EXEMPLARY EMBODIMENTS

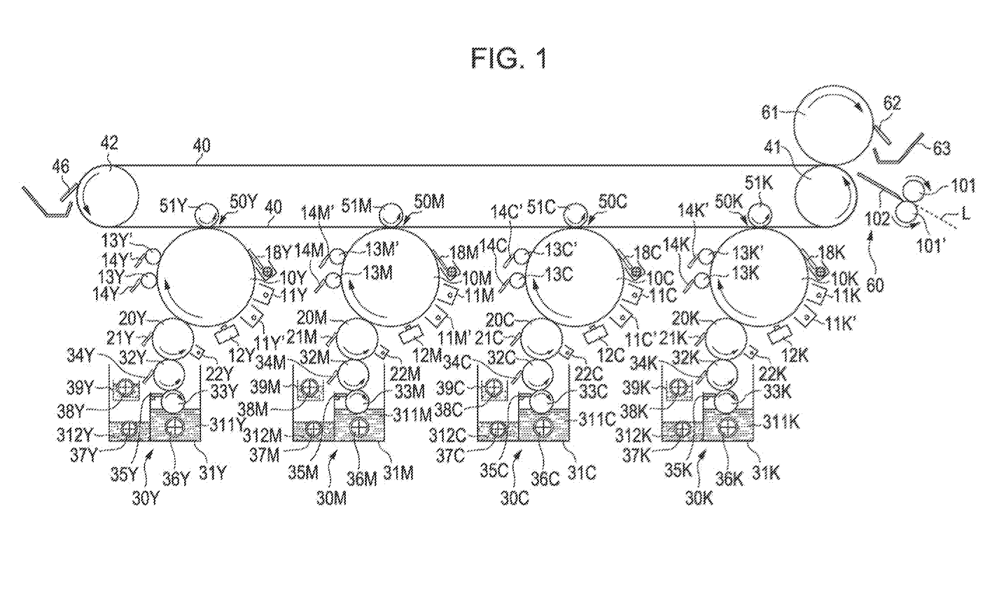

Hereinafter, embodiments of the invention will be described with described reference to the drawings. FIG. 1 is a view showing the main configuration of an image forming apparatus according to an embodiment of the invention. An image forming apparatus according to the embodiment includes four image forming units each having a transferring belt 40, and photoreceptors 10Y, 10M, 10C, and 10K, as a main configuration, four developing devices 30Y, 30M, 30C, and 30K disposed to correspond to the photoreceptors 10Y, 10M, 10C, and 10K (latent image carriers in the invention), a secondary transferring unit disposed at the right of the transferring belt 40 in the figure, and a cleaning unit and the like disposed at the left of the transferring belt 40 in the figure.

Hereinafter, the image forming units and the developing devices 30Y, 30M, 30C, and 30K for each color have the same configuration, such that the description is based on an image forming unit and a developing device for yellow (Y).

The developing unit 30Y is a device that develops a latent image formed on a photoreceptor 10Y by a liquid developer, and includes a developing roller 20Y, an intermediate roller 32Y, an anilox roller 33Y, a liquid developer container 31Y storing the liquid developer, and a toner charging unit 22Y that charges the toner on the developing roller 20Y, which are main components.

A developing cleaning blade 21Y, the intermediate roller 32Y, and the toner charging unit 22Y are disposed on the outer circumference of the developing roller 20Y. The surface of the intermediate roller 32Y is in contact with the developing roller 20Y and a supply roller 33Y and an intermediate roller cleaning blade 34Y is disposed on the outer circumference.

A regulator 35Y that adjusts the amount of the liquid developer drawn from a developer storage 311Y is in contact with the anilox roller 33Y. Further, in the triple-roller type using the intermediate roller 32Y, as in the image forming apparatus of the embodiment, it is possible to adjust the amount of the liquid developer by the intermediate roller 32Y being in contact with the supply roller 33Y, such that it may be possible to remove the regulator 35Y.

The liquid developer received in the developer container 31Y is not a volatile liquid, developer containing Isopar (Trade mark: Exxon) as a carrier and having low concentration (about 1 to 2 wt %), low viscosity, and volatility at room temperature, but a non-volatile liquid developer having high concentration, high viscosity, and non-volatility at room temperature. That is, the developer of the invention is a high-viscosity liquid developer (with viscoelasticity of about 30 to 300 mPa·s at shear velocity of 1000 (l/s) at 25° C., using HAAKE RheoStress RS600) produced by adding solids having the average particle diameter of 1 μm by dispersing a colorant, such as a pigment into thermoplastic resin, into a liquid solvent, such as an organic solvent, silicon oil, mineral oil, or food oil, together with a dispersant to have toner solid content concentration of about 25%.

The anilox roller 33Y functions as an applying roller that performs application by supplying the liquid, developer to the intermediate roller 32Y. The anilox roller 33Y is a roller that a. cylindrical member and has a concave-convex surface with fine and uniform spiral grooves on the surface to easily carry the developer onto the surface. The liquid developer is supplied from the developing container 31Y to the developing roller 20Y by the anilox roller 33Y. When the apparatus operates, as shown in the figure, the supply roller 33Y applies the liquid developer onto the intermediate roller 32Y while rotating clockwise.

The regulator 35Y is a metal blade with a thickness of about 200 μm and adjusts the amount of liquid developer that is supplied to the developing roller 20Y by regulating the thickness and amount of the liquid developer supported and transported by the anilox roller 33Y, in contact with the surface of the anilox roller 33Y.

The intermediate roller 32Y is a cylindrical member, and, as shown in the figure, is in counter-contact with the developing roller 20Y while rotating counterclockwise about the rotational center, similar to the developing roller 20Y. The intermediate roller 32Y is formed by disposing an elastic layer on a metallic core, similar to the developing roller 20Y.

An intermediate roller cleaning blade 34Y is disposed downstream from the contact position of the intermediate roller 32Y and the developing roller 20Y, in contact with the intermediate roller 32Y, such that the liquid developer that is not supplied to the developing roller 20Y is scraped and collected into a collecting container 312Y in the developer container 31Y.

The developing roller 20Y is a cylindrical member and rotates counterclockwise about a rotational center, as shown in the figure. The developing roller 20Y is formed by disposing an elastic layer, such as polyurethane rubber, silicon rubber, NBR, or PFA tube, on the outer circumference of a core made of metal, such as iron.

A developing roller cleaning blade 21Y (developing roller cleansing member) is implemented by rubber or the like which is in contact with the surface of the developing roller 20Y and scrapes the liquid developer remaining on the developing roller 20Y because the developing roller is positioned downstream in the rotational direction of the developing roller 20Y further than a developing-nipped portion being in contact with the photoreceptor 10Y. The developer remaining after development is scraped and removed by the developing roller cleaning blade 21Y and dropped into the collecting container 312Y in the developer container 31Y for reuse.

The toner charging unit 22Y is a unit that adjusts the charging state of the liquid developer applied on the surface of the developing roller 20Y and a corotron charging unit without a grid electrode on a discharge side is used in the embodiment. The liquid developer transported by the developing roller 20Y is charged by an electric field applied by corona discharge at a position close to the toner charging unit 22Y.

The photoreceptor 10Y is a photoreceptive drum, which is a cylindrical member with a photosensitive layer, such as an amorphous silicon photoreceptor, on the outer circumference, and rotates clockwise.

Two corona charging units 11Y and 11Y′ are disposed downstream further than the nipped portion of the photoreceptor 10Y and the developing roller 20Y in the rotational direction of the photoreceptor 10Y, and corona-charge the photoreceptor 10Y by receiving a voltage from a power supply unit (not shown). The photosensitive unit 12Y forms a latent image on the photoreceptor 10Y by radiating light onto the photoreceptor 10Y charged by the corona charging units 11Y and 11Y′, downstream further than the corona charging unit 11Y in the rotational direction of the photoreceptor 10Y.

The squeeze unit (“collecting unit” in the invention) disposed upstream further than the primary transferring unit 50Y is positioned at the downstream side of the developing roller 20Y, opposite to the photoreceptor 10Y. The photoreceptor squeeze device includes the first photoreceptor squeeze roller 13Y, which is an elastic roller rotating in contact with the photoreceptor 10Y, a second photoreceptor squeeze roller 13Y′, and photoreceptor squeeze roller member cleaning blades 14Y and 14Y′, and has a function of increasing the ratio of toner particles in an exposed image (toner image) by collecting remaining carrier liquid from the toner image developed on the photoreceptor 10Y and toner fog that was originally unnecessary. Further, a bias voltage for introducing the toner fog to the photoreceptor squeeze rollers 13Y and 13Y′ is applied to the photoreceptor squeeze rollers 13Y and 13Y′.

The photoreceptor squeeze roller cleaning blades 14Y and 14Y′ are disposed in contact with the photoreceptor squeeze rollers 13Y and 13Y′, respectively, and scrape the liquid developer containing the collected carrier liquid, or toner fog to be dropped into a collected-liquid storage 391Y. In the embodiment, the carrier-rich liquid developer collected from the photoreceptor squeeze device, as described above, is collected through a path different from the liquid developer collected from the developing roller 20Y into the collecting container 312Y.

The surface of the photoreceptor 10Y passing through the squeeze device composed of the first photoreceptor squeeze roller 13Y and the second photoreceptor squeeze roller 13Y∝ enters the primary transferring unit 50Y. In the primary transferring unit 50Y, the developer image developed on the photoreceptor 10Y is transferred to the transferring belt 40 by a primary transferring backup roller 51Y. In the primary transferring unit 50Y, the toner image on the photoreceptor 10Y is transferred onto the transferred belt 40 by transferring bias applied to the primary transferring backup roller 51Y. The photoreceptor 10Y and the transferring belt 40 move at a constant speed, such that driving load, due to rotation and movement, is reduced and disturbance on the exposed toner image of the photoreceptor 10Y is suppressed.

The photoreceptor cleansing blade 18Y that is in contact, with the photoreceptor 10Y removes the carrier-rich liquid developer on the photoreceptor 10Y, at the downstream side of the primary transferring unit 50Y, into the collected-liquid storage 181Y.

The transferring belt 40 (transferring member) has a triple-layered structure in which an elastic intermediate layer made of polyurethane is disposed on a polyimide base layer and a PFA surface layer is disposed thereon. The transferring belt 40 is held on a belt driving roller 41 and a tension roller 42 and used such that the toner image is transferred onto the PFA surface layer. In the image forming apparatus of the embodiment, although the transferring belt 40 is used as a member for transferring, it is not limited to the belt and various transferring members, such as a roller and a drum, may be employed.

In the primary transferring units 50Y, 50M, 50C, and 50K in which the photoreceptors 10Y, 10M, 10C, and 10K and the primary transferring backup rollers 51Y, 51M, 51C, and 51K are disposed opposite each other with the transferring belt 40 therebetween, a full-colored toner image is formed on the transferring belt 40 by sequentially transferring the toner images of the colors of the developed photoreceptors 10Y, 10M, 10C, and 10K on the transferring belt 40 to overlap each other, with the contact positions with the photoreceptors 10Y, 10M, 10C, and 10K as transferring positions.

In a secondary transferring unit 60, a secondary transferring roller 61 is disposed opposite a belt driving roller 41 with the transferring belt 40 therebetween, whereby a secondary transferring section (nipping section) is formed by the rollers. In the secondary transferring unit, the monochromic or full-colored toner image formed on the transferring belt 40 is transferred onto a transfer material, such as a sheet, a film, or a fabric, which is transported in a transfer material transporting path L. Further, a fixing unit (not shown) is disposed at a downstream side in the sheet transporting path L and fixes the monochromic toner image or full-colored toner image on the transfer material by applying heat.

The transfer material is supplied to the secondary-transferring unit by a sheet feeder (not shown). The transfer material set in the sheet feeder is sent out to the transfer material transporting path L one by one at predetermined timings. In the transfer material transporting path L, the transfer material is transferred to the secondary transferring unit by gate rollers 101 and 101′ and the monochromic or full-colored toner image formed on the transferring belt 40 is transferred onto the transfer material.

The tension roller 42 holds an intermediate transferring body 40 together with the driving roller 41 and a cleaning blade 46 that cleans the transferring belt 40 are disposed in contact with the position where the intermediate transferring body 40 is held on the tension roller 42.

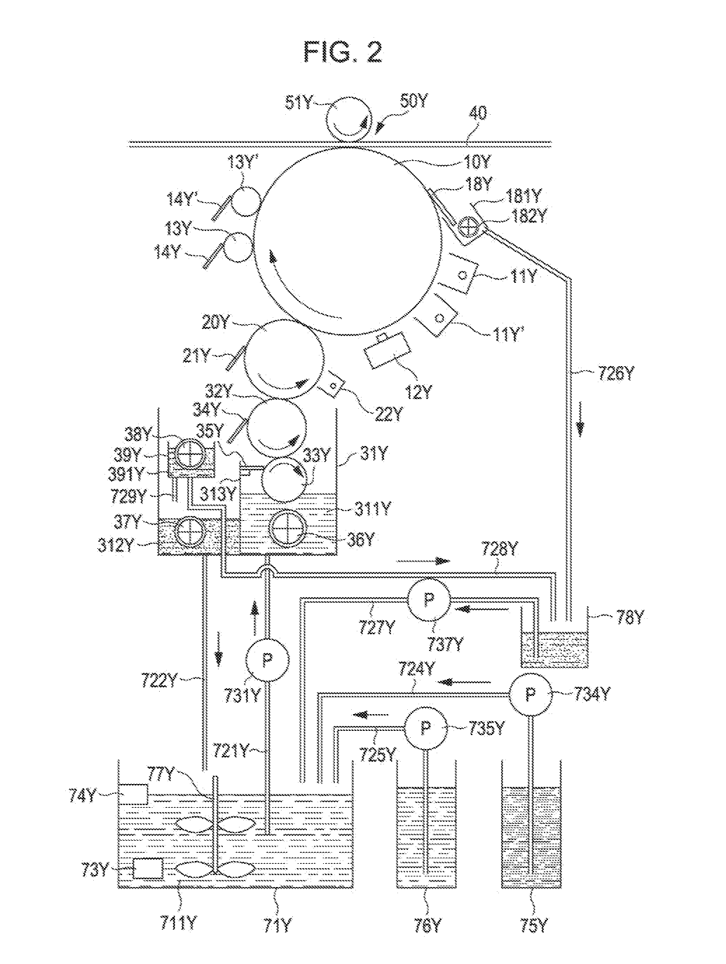

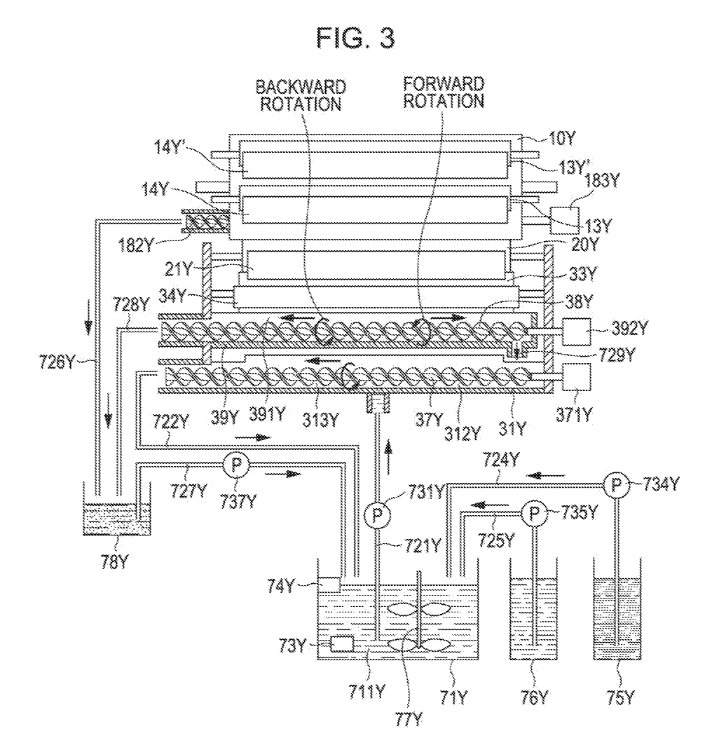

In the image forming apparatus, the image forming units for respective colors and a developer supply that supplies the liquid developer to the developing units are described. FIG. 2 is a cross-sectional view showing the main configurations of an image forming unit, a developing unit, and a developer supply unit according to an embodiment of the invention and FIG. 3 is a side view of the image forming unit and the developing unit and a cross-sectional view of the developer supply unit, according to an embodiment of the invention.

As shown in FIG. 2, the liquid developer storage 311Y storing the liquid developer supplied to the developing roller 20Y and the collecting container 312Y storing the collected liquid developer are disposed in the developing container 31Y in the developing unit 30Y. Further, the liquid developer storage 311Y and the collecting container 312Y are separated by a separating plate 313Y.

A side cross-sectional view of the developing unit 30Y seen from the collecting container 312Y is shown in FIG. 3. As shown in the figure, the separating plate 313Y has both ends that are partially notched, such that the heights of both ends are reduced. The liquid level keeps constant in the developer storage unit 311 by allowing the liquid developer to overflow from the liquid, developer storage 311 to the collecting container 312Y, at the notched portion, such that, it is possible to stably supply the liquid developer to the anilox roller 33Y. Further, the developer collected in the collecting container 312Y does not flow into the developer storage 311Y and the adjusted concentration of the liquid developer in the developer storage 311Y is not changed.

As described above, the liquid developer scraped by the developer roller cleaning roller 21Y and the intermediate roller cleaning blade 34Y, in addition to the liquid developer overflowing from the developer storage 311Y, is stored in the collecting container 312Y. In particular, the liquid collected from the developing roller 20Y receives an electric field from the toner charging unit 22Y and is compressed between the developing roller 20Y and the photoreceptor 10Y, such that a lot of the aggregation substance of toner particles is contained.

The collected liquid stored in the collecting container 312Y is supplied again to the developer storage 311 after the concentration is adjusted in the developer supply unit. As described above, the configuration of the developer supply unit for reusing the liquid developer is described.

The embodiment is provided with a high-concentration developer tank 76Y, a carriage liquid, tank 75Y, a concentration adjustment tank 71Y, a transporting path 721Y connecting the concentration adjustment tank 71Y with the developer storage 311Y, a transporting path 722Y connecting the collecting container 312Y with the developer supply unit, and the buffer tank 78Y temporarily stores the collected liquid developer, as the main configuration of the developer supply unit.

A supply developer storage 711Y that stores the liquid developer and adjusts the concentration is included in the concentration adjustment tank 71Y. It is possible to supply a high-concentration developer through a. transporting path 725Y from the high-concentration developer tank 76Y and the carrier liquid through a transporting path 724Y from a carrier liquid tank 75Y, into the supply developer storage 711Y. Although the developer is actively supplied by disposing pumps 735Y and 734Y in the transporting paths 725Y and 724Y, respectively, in the embodiment, valves may be employed instead of the pumps such that the developer is supplied by self weight, when fluidity is high.

Further, in the embodiment, the liquid developer stored in the collecting container 312Y is collected into the supply developer storage 711Y through the transporting path 722Y. An auger 37Y (second auger) that transport the liquid developer in the axial direction of the developing roller 20Y is disposed in the collecting container 312Y. The auger 37Y has a rotary shaft aligned in the axial direction of the developing roller 20Y and fins (blades) disposed around the rotary shaft. As the auger 37Y is rotated in a predetermined direction by an auger driver 371Y (second auger driver), such as a motor, the liquid developer stored in the collecting container 312Y is transported from the transporting path 722Y to the supply developer storage 711Y.

Further, in the embodiment the carrier-rich liquid developer collected from the squeeze device is collected, into the collected-liquid storage 391Y different from the collecting container 312Y. As shown in FIG. 2, the collected-liquid storage 391Y is disposed under the first squeeze roller cleaning blade 14Y and the second squeeze roller cleaning blade 14Y′, such that the liquid developer dropped by the blades is collected into the collected-liquid storage 391Y.

Further, as shown in FIG. 3, a first transporting path 729Y for transporting the liquid developer into the collecting container 312Y and a second transporting path 728Y for transporting the liquid developer to the buffer tank 78Y are disposed in the collected-liquid storage 391Y. Further, an auger 38Y (first auger) transporting the liquid developer to the first transporting path 729Y or the second transporting path 728Y while rotating forward/backward is disposed in the collected-liquid storage 391Y. The auger 38Y has substantially the same configuration of the auger 37Y (second auger) described above and is composed of a rotary shaft having the same axis as the developing roller 20Y and fins (blades) disposed around the rotary shaft. In the embodiment, the liquid developer stored in the collected-liquid storage 391Y is transported to the first transporting path 729Y of the second transporting path 728Y by rotating forward/backward the auger 38Y with an auger motor 392Y (first auger driver).

When the auger 38Y is rotated forward, the liquid developer in the collected-liquid storage 391Y is transported to the collecting container 312Y by the first transporting path 729Y. In the embodiment, particularly, by dropping (transporting) the liquid developer to the upstream position in the transporting of the liquid developer, that is, to the position opposite to the transport direction of the auger 37Y, in the collecting container 312Y, such that the toner concentration of the liquid developer discharged from the collecting container 312Y is made uniform. Further, the first transporting path 729Y is not limited to the embodiment and may transport the liquid developer to the supply developer storage 711Y.

On the other hand, when the auger 38Y is operated backward by the auger driver 392Y, the liquid developer in the collected-liquid storage 391Y is transported to the buffer tank 78Y through the second transporting path 728Y. In the embodiment, a change in concentration and a change in liquid level of the liquid developer stored in the supply developer storage 711Y are controlled by switching the first transporting path 729Y and the second transporting path 728Y. Further, in the embodiment, although the transport performance by switching the transport destination of the liquid developer by using the transport direction of the auger 38Y, the transport destination can be switched in various ways.

Further, in the embodiment, a collected-liquid storage 181 for receiving the liquid developer collected by the photosensitive cleaning blade 18Y, and an auger 182Y (third auger) are disposed to reuse the liquid developer collected from the photoreceptor 10Y after the first transferring by the photosensitive cleaning blade 18Y. The auger 182Y has substantially the same configuration as the auger 37Y and transports the liquid developer, which is collected from the entire region of the photoreceptor 10Y and stored in the collected-liquid storage 181 in the rotation by the auger driving portion 183Y (third auger driving portion), to the axial direction of the photoreceptor 10Y and transports the liquid developer to the buffer tank 78Y through the transporting path 726Y.

The buffer tank 78Y is a storage that temporarily stores the liquid developer collected by the auger 38Y and the auger 182Y and the stored liquid developer is transported to the supply developer storage 711Y through the transporting path 727Y and reused. The liquid developer is transported by a pump 737Y in the embodiment.

A concentration sensor 73Y that senses toner concentration in the stored liquid developer, a liquid level sensor 74Y that senses the amount of liquid, and a stirring member 77Y that stirs the liquid developer to make the concentration uniform are disposed in the supply developer storage 711Y formed in the concentration adjustment tank 71Y. The concentration sensor 73Y can keep the toner concentration (solid concentration 25%) and the amount of the liquid developer stored in the supply developer storage 711Y by stirring the developer with the stirring member 77Y, by driving the pumps 735Y and 734Y, on the basis of output from the liquid level sensor 74Y. In the embodiment, since the liquid developer stored in the buffer tank 78Y is transported by the pump 737Y, it may be possible for the pump 737Y to control the transport amount by using at least one of the liquid level sensor 74Y and the concentration sensor 73Y. Further, it may be possible to control the pump 737Y such that the liquid developer in the buffer tank 78Y does not overflow, on the basis of the amount of liquid in the buffer tank 78Y by disposing a liquid level sensor that monitors the amount (level) of liquid in the buffer tank 78Y.

The liquid developer of which the concentration is adjusted is used to form the image transported to the developer storage 311Y of the developing unit 30Y through the transporting path 721Y by the pump 731Y. The configuration of the developer supply unit was described above with reference to FIGS. 2 and 3, but the liquid developer can be adjusted in concentration and reused by the supply of liquid, developer described above.

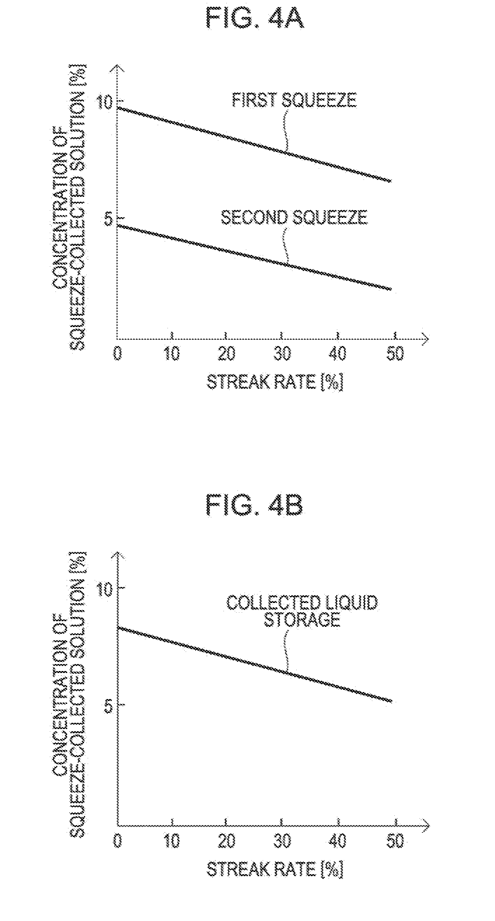

Switching of the first transporting path 729Y and the second transporting path 728Y of the embodiment is described hereafter. FIGS. 4A and 4B are views showing the relationship the toner concentration of the liquid developer collected from the squeeze device (collecting device) and formed image, that is, the streak rate of a latent image formed on the photoreceptor 10Y in the exposing unit 12Y, when the auger 38Y keeps rotating forward.

FIG. 4A is a view showing the relationship between the streak rate and the toner concentration of the liquid developer collected by the first squeeze roller cleaning blade 14Y and the second squeeze roller cleaning blade 14Y′. As shown in the figure, the toner concentration of the liquid developer collected by both of the cleaning rollers 14Y and 14Y′ decreases with the increase in streak rate. Further, most, of the toner fog is collected by the first squeeze roller cleaning blade 14Y, such that the toner concentration of the liquid toner collected by the second squeeze roller cleaning blade 14Y′ is lower than the concentration of the liquid developer collected by the first squeeze roller cleaning blade 14Y. Further, the collecting amount of the second squeeze roller cleaning blade 14Y′ is substantially the half of that of the first squeeze roller cleaning blade 14Y.

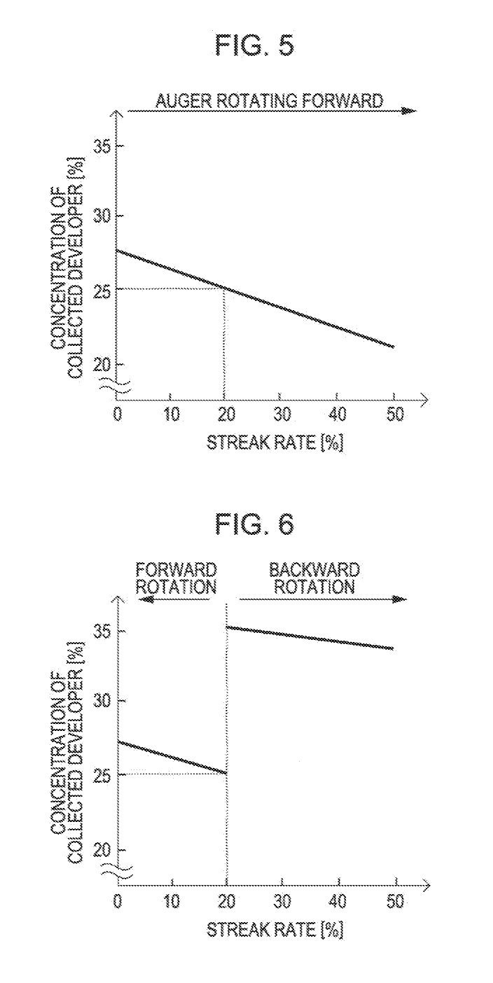

FIG. 4B shows the relationship between the streak rate and the toner concentration of the liquid developer collected by both of the squeeze roller cleaning blades 14Y and 14Y′, that is, the liquid developer stored in the collected-liquid storage 391Y. Similar to FIG. 4A, it can be seen that the toner concentration of the liquid developer stored in the collected-liquid storage 391Y intends to decrease with the increase in streak rate. Further, FIG. 5 is a view showing the relationship between the streak rate of a formed image and the toner concentration of the liquid developer discharged from the collecting container 312Y (collected liquid developer concentration), when the auger 38Y keeps rotating forward.

It is preferable to maintain the toner concentration of the liquid developer supplied to the liquid developer storage 311Y from the supply developer storage 711Y at a desired value (25% in the embodiment). As can be seen from the relationship in FIG. 5, the toner concentration of the liquid developer discharged from the collecting container 312Y changes to an appropriate value from the streak rate of 20%. That is, when the streak rate is 20% or more, the toner used for developing increases, such that the toner concentration of the collected liquid developer decreases. On the other hand, when the streak rate is 20% or less, the toner used for developing decreases, such that the toner concentration of the collected liquid developer increases.

A first embodiment of switching-control of the transporting path of the invention is described hereafter. In the first embodiment, switching to the first transporting path 729Y or the second transporting path 728Y is performed on the basis of the streak rate of a formed image. The transport performance of the liquid developer in the collected-liquid storage 391Y is increased by controlling the rotational direction of the auger 38Y in the embodiment.

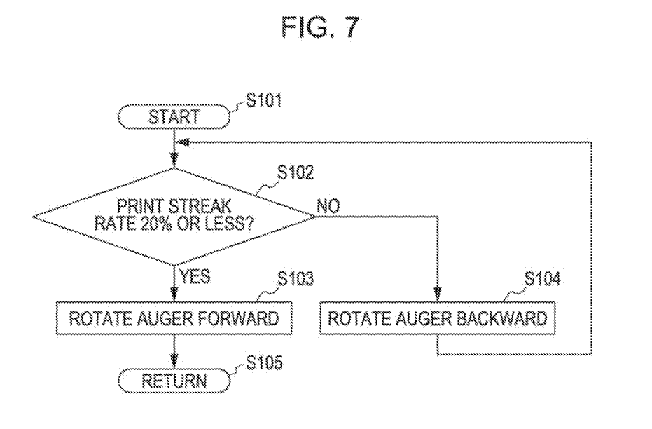

FIG. 6 is a view showing the relationship of the streak path of a formed image and the toner concentration of the liquid developer discharged from the collecting container 312Y and FIG. 7 is a flowchart showing drive control of an auger. In the embodiment, the rotational direction of the auger 38Y is changed, at an appropriate value (2.5%) of the toner concentration of the supply developer storage 711Y. In the flowchart of FIG. 7, in S102, the rotational direction of the auger 38Y is changed on the basis of whether the streak rate is below 20% or not, by monitoring the streak rate of the image information that is printed.

When the streak rate is below 20%, the liquid developer is transported to the first transporting path 729Y that easily influences a change in concentration of the supply developer storage 711Y by rotating the auger 38Y forward (S103). On the other hand, when the streak rate is not below 20%, the liquid developer is transported to the second transporting path 729Y by rotating the auger 38Y backward to suppress a rapid change in concentration in the supply developer storage 711Y (S104).

As the transporting paths are switched, it is possible to suppress a rapid drop in concentration of the liquid developer stored in the supply developer storage 711Y, even if printing is performed with a high streak rate. When the control is performed, as shown in FIG. 6, the toner concentration of the liquid developer discharged from the collecting container 312Y, that is, the liquid developer collected in the supply developer storage 711Y is maintained at 25% or more.

Although the transporting paths are switched, on the basis of the streak rate of the formed image in the first embodiment, the transporting paths may be switched, on the basis of the toner concentration and the amount of the liquid developer stored in the supply developer storage 311Y (second embodiment). As described above, the concentration sensor 73Y detecting the toner concentration of liquid developer and the liquid level sensor 74Y detecting the liquid level (liquid amount) are disposed in the supply developer storage 711Y. The outputs of the sensors are input to the control unit that switches the auger 38Y and used to determine switching to forward rotation and backward rotation.

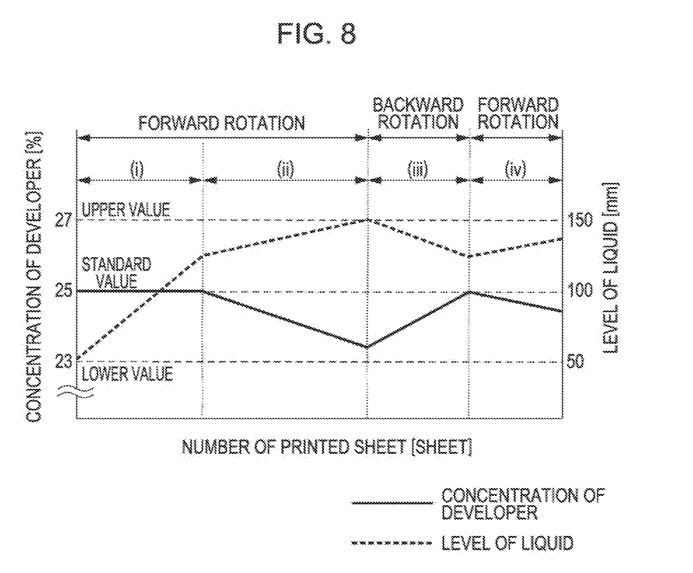

Changing of the rotational direction of the auger 38Y is described hereafter. FIG. 8 is a view showing a process of changing the rotational direction of the auger 38Y, in which changes in the concentration and the level of the liquid developer in the supply developer storage 711Y according to the increase in the number of printed sheets in the image forming apparatus are shown. Further, the example shows the control when printing is continued with the streak rate of 20% or more.

The concentration and the level of the liquid developer are detected by the concentration sensor 73Y and the liquid level sensor 74Y, respectively. The concentration and the level of the developer have a reference value, an upper limit, and a lower limit, such that they are controlled between the upper limit and the lower limit. In the embodiment, the reference value is 25%, the upper limit is 27%, and the lower limit is 23%, of the concentration of the developer. Meanwhile, the reference value is 100 mm, the upper limit is 150 mm, and the lower limit is 50 mm, of the liquid level.

The auger 38Y is rotated forward after printing is started, that is, in the region i shown in FIG. 8. In the region i, it is necessary to supply a high-concentration developer higher than the high-concentration developer tank 76Y in order to maintain the concentration of the liquid developer in the supply developer storage 711Y at a constant value of 25% because a low-concentration liquid developer flows inside from the collected-liquid developer 391Y, such that the liquid level in the supply developer storage 711Y increases.

Therefore, in the region ii, the increase in liquid level is attenuated by decreasing the desired value of the concentration of the liquid developer stored in the supply developer storage 711Y to the lower limit (23%). Further, when the liquid level increases and reaches the upper limit (100 mm), the low-concentration liquid developer stored in the collected-liquid storage 391Y is prevented from being transported to the supply developer storage 711Y by rotating backward the auger 38Y, such that the increase in liquid, level is changed to decrease and the toner concentration is increased. The desired value of the concentration is restored to the reference value (25%) in this process (region iii).

The auger 38Y is switched to rotate forward when the concentration returns to the reference value by keeping the auger 38Y rotating backward in the region iii. By returning to the forward rotation, as described above, the tanks having a limitative capacity is prevented from being full, by suppressing the transport amount to the buffer tank 78Y, which is the transport destination in backward rotation. Substantially the same control as in the region ii is performed in the region iv where the rotation is switched to the forward rotation, in which the auger 38Y rotates forward and the desired value of the concentration is set to the reference value (25%).

Although the rotational direction of the auger 38Y is changed by the toner concentration and the level of the liquid developer stored in the supply developer storage 711Y in the control of the second embodiment, the control may be performed by any one of the toner concentration and the level, in addition to using both of them.

As described above, in the embodiment, as the liquid developer collected from the squeeze unit (collecting unit) is switched to the first transporting path 729Y that largely influences the toner concentration of the liquid developer stored in the supply developer storage 711Y and the second transporting path 728Y that less influences the toner concentration, it is possible to supply an image forming apparatus that can perform continuous printing by suppressing the changes in concentration and level of the liquid developer stored in the supply developer storage 711Y, even if the concentration of the collected liquid developer is changed by the change of the streak rate.

Further, although various embodiments are described herein, other embodiments implemented by appropriately combining the configurations of the embodiments are included in the scope of the invention.

The entire disclosure of Japanese Patent Application No. 2011-029311, filed Feb. 15, 2011 is expressly incorporated by reference herein.

What is claimed is:

1. A collecting device comprising:
a collecting unit that collects a liquid developer containing toner and a carrier liquid;
a collected-liquid storage that stores the liquid developer collected by the collecting unit;
a first transporting path that transports the liquid developer stored in the collected-liquid storage;
a second transporting path that transports the liquid developer stored in the collected-liquid storage; and
a control unit that switches transportation of the liquid developer stored in the collected-liquid storage to the first transporting path or the second transporting path.

2. The collecting device according to claim 1, further comprising:
an auger disposed in the collected-liquid storage and transporting the liquid developer stored in the collected-liquid storage by rotating,
wherein the control unit transports the liquid developer to the first transporting path or the second transporting path by changing the rotational direction of the auger.

3. An image forming apparatus comprising:
a latent image carrier that forms a latent image;
an exposing unit that forms the latent image on the latent image carrier;
a developing unit that includes a developing roller developing the latent image formed on the latent image carrier by carrying a liquid developer containing toner and a carrier liquid;
a squeeze unit that includes a squeeze roller squeezing the latent image carrier in contact with the latent image carrier where the latent image is developed and a squeeze roller cleaning member collecting the liquid developer by cleaning the squeeze roller in contact with the squeeze roller;
a collected-liquid storage that stores the liquid developer collected by the squeeze roller cleaning member;
a first transporting path that transports the liquid developer stored in the collected-liquid storage;
a second transporting path that transports the liquid developer stored, in the collected-liquid storage; and
a control unit that switches transportation of the liquid developer stored in the collected-liquid storage to the first transporting path or the second transporting path.

4. The image forming apparatus according to claim 3,
wherein the developing unit includes a developing roller cleaning member that collects the liquid developer by cleaning the developing roller in contact with the developing roller and a collecting container that stores the liquid developer collected by the developing roller cleaning member, and
the first transporting path transports the liquid developer stored in the collected-liquid storage to the collecting container.

5. The collecting device according to claim 3, further comprising:
an auger disposed in the collected-liquid storage and transporting the liquid developer stored in the collected-liquid storage,
wherein the control unit transports the liquid developer to the first transporting path or the second transporting path by changing the rotational direction of the auger.

6. The image forming apparatus according to claim 5, further comprising:
a second auger that transports the liquid developer stored in the collecting container from one side to the other side in the axial direction of the developing roller,
wherein the first transporting path transports the liquid developer to one side of the collecting container,

7. The image forming apparatus according to claim 3, further comprising:
a developer supply unit that supplies the liquid developer to the developing unit,
wherein the second transporting path transports the liquid developer stored in the collected-liquid storage to the developer supply unit.

8. The image forming apparatus according to claim 3,
wherein the control unit switches transportation of the liquid developer to the first transporting path or the second transporting path on the basis of the toner concentration of the liquid developer stored in the developer supply unit or the liquid amount in the developer supply unit.
